(19) United States
(12) Patent Application Publication
(10) Pub. No.: US 2025/0028113 A1
(43) Pub. Date: Jan. 23, 2025

(54) Integrated Edge Coupler

(71) Applicant: LiGenTec SA, Ecublens (CH)

(72) Inventors: Thomas HESSLER, Ecublens (CH); Jeroen GOYVAERTS, Ecublens (CH); Mariam BENEFAQUIH, Ecublens (CH); Alvaro JIMENEZ, Ecublens (CH); Davide Sacchetto, Ecublens (CH)

(73) Assignee: LiGenTec SA, Ecublens (CH)

(21) Appl. No.: 18/711,793

(22) PCT Filed: Nov. 22, 2022
(86) PCT No.: PCT/EP2022/082827

§ 371 Date: May 20, 2024

(30) Foreign Application Priority Data
Nov. 22, 2021 (GB) 2116798.6

(51) Int. Cl. G02B 6/12; G02B 6/122; G02B 6/14; G02B 6/30

(52) U.S. Cl. CPC G02B 6/12002; G02B 6/12004; G02B 6/1228; G02B 6/14; G02B 6/305; G02B 2006/12147; G02B 2006/12152

(57) ABSTRACT

An optical mode-size converter is presented, which extends between a first plane to a second plane along a first path. The optical mode-size converter comprises: a plurality of dielectric strips within a coupling layer arranged to receive a beam with a first optical mode incident on the first plane, wherein the plurality of dielectric strips are coupled to each other in a first evanescent coupling region; and a first waveguide within a functional layer disposed above or below the coupling layer, the waveguide supporting a second optical mode and traversing the second plane. At least one of the plurality of dielectric strips is evanescently coupled to the first waveguide in a second evanescent coupling region. The first optical mode has a larger mode size than the second optical mode such that the converter is responsive to the first optical mode incident on the first plane to convert the first optical mode into the second optical mode in the first waveguide, along the first path towards the second plane.

### TECHNICAL FIELD

This specification relates to an optical coupler.

### BACKGROUND

In recent years, a plethora of applications based on photonic integrated circuits (PICs) have emerged including data centre communications, coherent telecommunications, filters, supercontinuum generation, spectroscopy, biosensing, quantum optics and microwave photonics. With the increasing interest in the emerging photonic circuits, a successful photonic platform requires low-loss waveguide circuits.

### SUMMARY

According to an aspect of the present invention, there is provided an optical mode-size converter, extending between a first plane to a second plane along a first path. The optical mode-size converter comprises a plurality of dielectric strips within a coupling layer arranged to receive a beam with a first optical mode incident on the first plane, wherein the plurality of dielectric strips are coupled to each other in a first evanescent coupling region; and a first waveguide within a functional layer disposed above or below the coupling layer, the waveguide supporting a second optical mode and traversing the second plane. At least one of the plurality of dielectric strips is evanescently coupled to the first waveguide in a second evanescent coupling region. The first optical mode has a larger mode size than the second optical mode, such that the converter is responsive to the first optical mode incident on the first plane to convert the first optical mode into the second optical mode in the first waveguide, along the first path towards the second plane.

In some implementations, the plurality of dielectric strips comprises a centre waveguide aligned with the first waveguide in plan view; a left waveguide; and a right waveguide. The left waveguide and the right waveguide start at the first plane, and disposed at opposite sides from each other with respect to the centre waveguide. A first portion of the centre waveguide is evanescently coupled to the left waveguide and the right waveguide in the first evanescent coupling region. A second portion of the centre waveguide is evanescently coupled to the first waveguide in the second evanescent coupling region.

In some implementations, the left waveguide and the right waveguide have the identical dimensions.

In some implementations, the left waveguide and the right waveguide are positioned at symmetric positions with respect to a centre of the first optical mode.

In some implementations, a width of the first waveguide gradually increases towards the second plane.

In some implementations, in the first evanescent coupling region, a width of the left waveguide and a width of the right waveguide gradually decrease towards the second plane, and a width of the first portion of the centre waveguide increases gradually towards the second plane.

In some implementations, a distance between side surfaces of the left waveguide and the first portion of the centre waveguide and a distance between side surfaces of the right waveguide and the first portion of the centre waveguide are constant within the first evanescent coupling region.

In some implementations, in the second evanescent coupling region, a width of the second portion of the centre waveguide decreases gradually towards the second plane, and a width of the first waveguide increases gradually towards to second plane.

In some implementations, the first waveguide starts at the first plane.

In some implementations, the first waveguide starts at the second evanescent coupling region.

In some implementations, the first waveguide comprises a first layer and a second layer, and an end of the second layer is closer to the first plane than an end of the first layer.

In some implementations, the converter is embedded in a waveguide chip, and the first plane comprises a facet of the waveguide chip.

In some implementations, a trench wherein a material is removed near the first plane at a first distance from the centre of the first optical mode, configured to guide the first optical mode incident on the first plane.

### BRIEF DESCRIPTION OF THE DRAWINGS

Certain embodiments of the present invention will now be described, by way of example, with reference to the accompanying drawings, in which:

FIG. 1 is a schematic that illustrates an exemplary embodiment of a mode-size converter.

FIGS. 2a and 2b are a schematic that illustrates an exemplary embodiment of the mode-size converter.

FIG. 3 is a schematic that illustrates an exemplary embodiment of a layer stack for photonic integrated circuit.

FIG. 4 is a schematic that illustrates an exemplary embodiment of the mode-size converter.

FIGS. 5a and 5b are a schematic that illustrates an exemplary embodiment of the mode-size converter.

FIG. 6 is a simulation result of the coupling loss of the mode-size converter.

### DETAILED DESCRIPTION

Waveguide circuits for photonic applications may include more than one type of waveguides, each with a different mode area. In this case, it may be required to convert one guided mode to another with low transmission loss. For example, light from an optical fiber may be coupled from a photonic chip and the coupling should be achieved with low coupling loss. For another example, two or more waveguides with different mode areas may be fabricated within a waveguide chip and the connection between these waveguides should be achieved with minimum possible loss. In order to reduce power loss, a mode-size converter for converting one optical mode to another with low loss may be devised and disposed between waveguides having different mode areas.

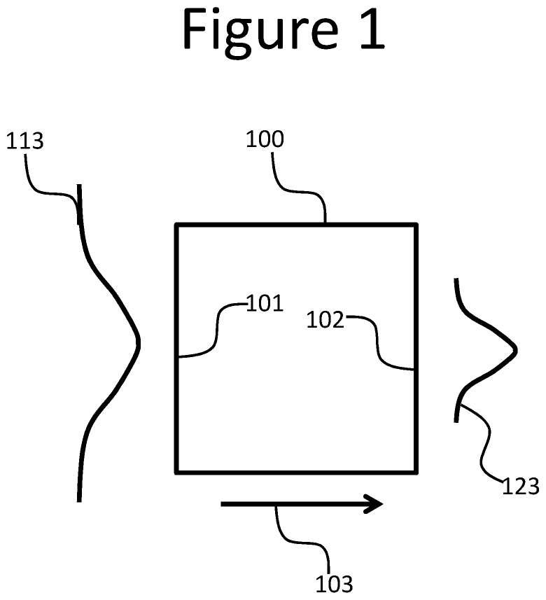

FIG. 1 is a schematic that illustrates an exemplary embodiment of a mode-size converter.

The mode-size converter 100 may be disposed between a first plane 101 and a second plane 102 within a photonic structure. The first plane 101 is configured to receive a first guided mode 113 or a first optical mode 113 that is incident on the first plane 101.

In some implementations, at the second plane 102, the first waveguide 120 may extend into a waveguide configured to support at least a second guided mode 123 or a second optical mode 123.

The second plane 102 may be defined within the waveguide chip and may not be a physical boundary defined by, for example, the discontinuity of the refractive index. For example, the mode-size converter 100 may be fabricated within a waveguide chip. In this case, the second plane 102 may not defined as a planar end perpendicular to the first direction 103 but a general area of transition between the mode-size converter 100 and the waveguide connected to the mode-size converter.

In this specification, the mode area of the first guided mode 113 will be assumed to be larger than the mode area of the second guided mode 123. This is to illustrate that the mode-size converter 100 can be used for converting a first optical mode 113 with a first predetermined mode area to a second optical mode 123 with a second predetermined mode area, wherein the first predetermined mode area is larger than the second predetermined mode area.

The first guided mode 113 may be incident on the first plane 101, be converted into the second guided mode 123 within the mode-size converter 100 and exit through the second plane 102. Alternatively, the second guided mode 123 may be incident on the second plane 102, be converted into the first guided mode 113, within the mode-size converter 100 and exit through the first plane 101. The mode-size converter 100 may operate in both directions. The mode-size converter 100 may be a reciprocal device, as will be explained in more detail below.

The mode-size converter 100 may be a reciprocal device as far as the mode properties are concerned. In other words, the guided mode travelling in a first direction 103, from the first plane 101 to the second plane 102 of the mode-size converter 100, may be converted from the first guided mode 113 to the second guided mode 123 by the mode-size converter 100. The guided mode travelling opposite the first direction 103 may be converted from the second guided mode 123 to the first guided mode 113 by the mode-size converter 100. The spatial distribution of the electromagnetic modes within the mode-size converter 100 may be substantially the same except the propagation direction. Therefore, the mode-size converter 100 can be used both for converting the first guided mode 113 into the second guided mode 123, and for converting the second guided mode 123 into the first guided mode 113. The mode properties of the incident guided modes 113, 123 may be converted in a reciprocal fashion by the mode-size converter 100.

The mode-size converter 100 may be a passive and reciprocal device. For example, the mode-size converter 100 may comprise a dielectric material, such as silicon dioxide or silicon nitride, which is largely transparent at the operating wavelength of the guided modes 113, 123 incident on the mode-size converter 100, without amplification or magneto-optical activity.

The mode-size converter 100 may provide a larger conversion efficiency at least compared to the case where a waveguide supporting the first optical mode 113 is simply brought into proximity of, so-called butt coupled to, another waveguide supporting the second optical mode 123. In this case, the efficiency of coupling is determined by an overlap integral between the two guided modes 113, 123. Since the conversion efficiency diminishes as the difference in the sizes of the transverse guided modes 113, 123 increases, this may not be practical for many photonic applications.

The mode-size converter 100 may be used with any waveguide capable of supporting guided modes 113, 123 or any optical modes with a well-defined supported modes, such as a transverse mode.

The mode-size converter 100 may be arranged to support the propagation of an electromagnetic mode within the mode-size converter 100, which gradually changes from the first guided mode 113 near the first plane 101 to the second guided mode 123 near the second plane 102. The area of the guided mode may gradually change as it propagates within the mode-size converter 100.

In an ideal case, the conversion from the first guided mode 113 to the second guided mode 123 may be substantially lossless if the first guided mode 113, which enters the first end 101, may gradually change to the second guided mode 123 towards the second end 102 substantially without substantial loss. The mode-size converter 100 may be designed to minimise loss in conversion from the first guided mode 113 to the second guided mode 123.

The waveguides interfaced at the first plane 101 and the second plane 102 may support more than one mode. In that case, the mode-size converter 100 may be designed to convert at least one of the supported modes of the waveguides. For the rest of the specification, the lowest order mode supported by each waveguide will be considered. However, the concept described in this specification may be applied to any desired modes of supported by the waveguides.

The examples of the waveguides include single-mode fibres, multi-mode fibres, UV-written waveguides, SOI (silicon-on-insulator) waveguides, polymer waveguides, waveguides defined by microfluidic channels. However, the examples of waveguides are not limited to these examples.

It is assumed that the first direction 103, in which the guided mode travels within the optical mode-size converter 100, is straight, extending in a linear line. However, the first direction 103 may be curved, following a predetermined path within the optical mode-size converter 100. In this case, the features described using the phrase ‘in the first direction’ or ‘towards the second end’ in this specification may be understood to be ‘along the predetermined path’ if the optical mode-size converter 100 supports a guided mode in the predetermined path which is not straight.

The mode-size converter 100 may possess any further optical properties than mode conversion, such as magneto-optical property or gain property, where the behaviour of the guided modes 113, 123 depends on whether the guided modes 113, 123 are incident on the first end 101 or the second end 102, in other words, which are non-reciprocal. Therefore, the mode-size converter 100 may not be a reciprocal device in one or more properties of light, which are largely independent from the mode properties of the guided modes 113, 123.

For example, the mode-size converter 100 may be a material which allows a magneto-optic manipulation such that the polarisation of the guided mode travelling within the made conversion device 100 may undergo a non-reciprocal rotation under the influence of a magnetic field. However, this property may not interfere with the mode propagation properties of the mode-size converter 100. The magneto-optical activity will not heavily affect the mode properties of the guided modes 113, 123 and the operation of the mode-size converter 100 in relation to the mode properties.

For another example, the mode-size converter 100 may be an active device. In other words, the mode-size converter 100 may be arranged to amplify the intensity of the guided modes 113, 123 incident on the mode-size converter 100 as they propagate through the mode-size converter 100. The mode-size converter may comprise one or more doped solid state materials such as Nd:YAG, Ti:Sa or one or more dielectric materials doped with ions such as Erbium or one or more semiconductor optical amplifier materials such as GaAs/AlGaAs. However, this property may not interfere with the mode propagation properties of the mode-size converter 100. The properties related to the amplification will not heavily affect the mode properties of the guided modes 113, 123, for example, from the thermal effects, and the operation of the mode-size converter 100 in relation to the mode properties.

It will be assumed in this specification, unless otherwise noted, that the first guided mode 113 and the second guided mode 123 and the propagating mode within the mode-size converter 100 are an electromagnetic wave centred at a single operating wavelength. For example, the first guided mode 113 and the second guided mode 123 may be a laser beam at 1550 nm wavelength.

Multiple wavelengths may be operable with the mode-size converter 100 as long as they do not affect the operation at the other wavelength. For example, if two laser wavelengths, 1550 nm and 1551 nm, or any two wavelengths within the C-band (1530 nm to 1565 nm) may be used with one mode-size converter 100 simultaneously insofar as any of the two laser lights do not induce thermal effects or nonlinear effects within the mode-size converter 100 and both wavelengths are supported by the waveguides and the mode-size converter 100.

The mode-size converter 100 may be embedded within or fabricated as a part of a waveguide chip.

In some implementations, when the first plane 101 may be a facet of the waveguide chip, the first optical mode 113 or the first guided mode 113 may be supported by a single mode fiber (SMF). A cleaved end of the single mode fiber, may be approached to the facet of the waveguide chip, the first plane 101, such that the first guided mode 113 may be incident on the facet of the waveguide chip, the first plane 101.

The propagating mode incident from the single mode fiber, the first optical mode 113, may be converted within the mode-size converter 100 into the second optical mode 123, within the waveguide chip, and exit through the second plane 102, formed within the waveguide chip.

In some implementations, when the first plane 101 may be a facet of the waveguide chip, the first optical mode 113 or the first guided mode 113 may be provided with a free-space propagating beam of light incident on the first plane 101 or the facet of the waveguide chip. For example, a laser beam with a transverse Gaussian intensity profile may be focused and directed to be incident on either the facet of the waveguide chip.

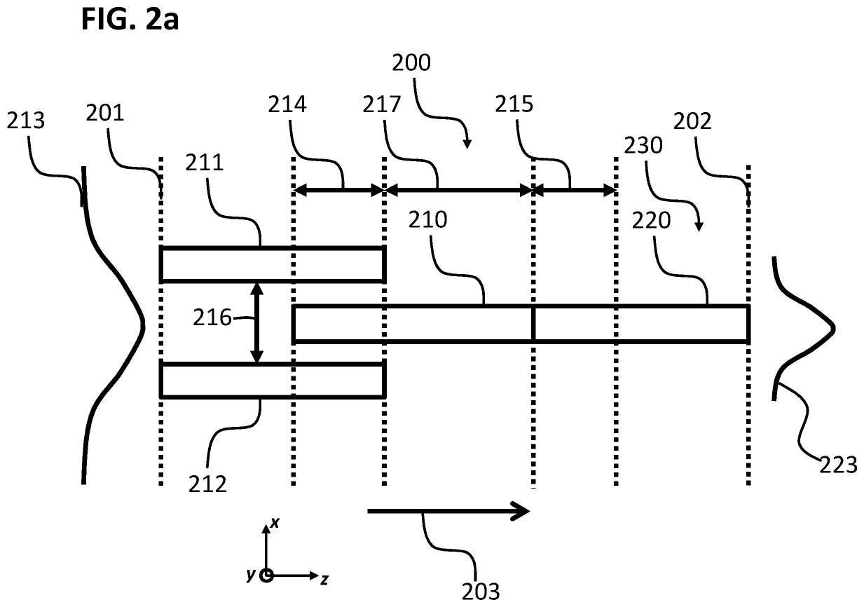

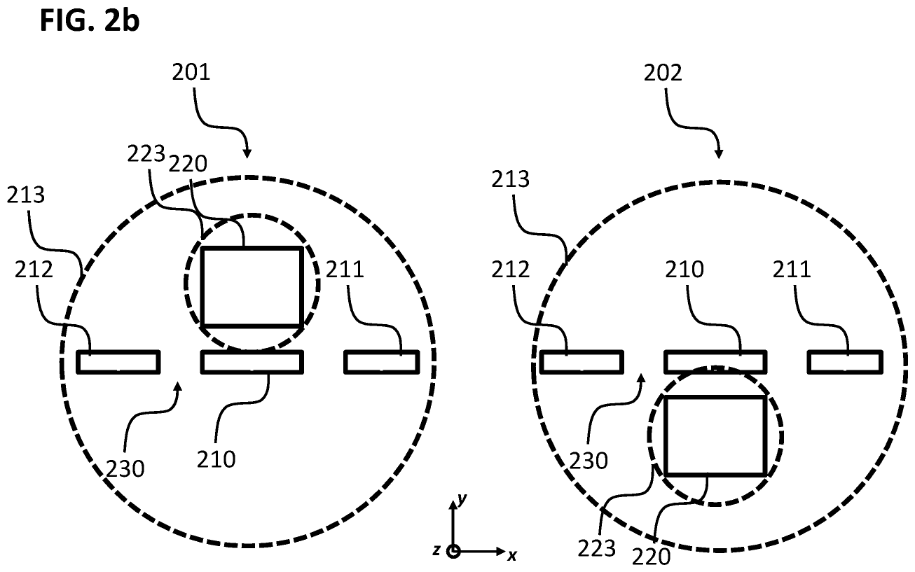

FIGS. 2a and 2b are a schematic that illustrates an exemplary embodiment of the mode-size converter 200 with references to FIG. 1.

In the example of FIGS. 2a and 2b, it will be assumed that the mode area of the first guided mode 213 is larger than the mode area of the second guided mode 223.

The operation of the mode-size converter 200 will be described mainly following the electromagnetic mode propagating in the first direction 203, namely from a larger first guided mode 213 to a smaller second guided mode 223.

However, since the mode-size converter 200 is a reciprocal device as discussed above, the operating principle described below also applies to an electromagnetic mode propagating in an opposite direction to the first direction 203 in a reverse order.

The mode-size converter 200 is configured such that when the first optical mode 213 is incident on the first plane 201, the first optical mode 213 is converted to the second guided mode 223 as it propagates through the mode-size converter 200 in the first direction 203 towards the second plane 202.

The first plane 201 and the second plane 202 may be a planar interface within a waveguide chip or defined as a general transition region from the mode-size converter 200 within a waveguide chip. The examples of the first plane 201 and the second plane 202 are not limited to these examples. The boundaries of the mode-size converter 100, 200 will be referred to as the first plane 201 and the second plane 202.

In some implementations, the first plane 201 may be a facet of a waveguide chip.

The mode-size converter 200 includes a centre waveguide 210, a left waveguide 211, a right waveguide 212 and a first waveguide 220, which all extend in the propagation direction of the first optical mode 213 and the second optical mode 223, the z-direction in the FIGS. 2a and 2b.

In this specification, the term “waveguide” is understood to be or used interchangeably as a core of the waveguide, which has a refractive index higher than the immediate surroundings. For example, it is understood that the centre waveguide 210, the left waveguide 211, the right waveguide 212 and the first waveguide 220 are waveguide cores embedded in a cladding material, or in a material with a refractive index lower than the waveguides. However, it is noted that the concept presented in this specification also applies to graded index waveguides.

The centre waveguide 210, the left waveguide 211, the right waveguide 212 and the first waveguide 220 may comprise a dielectric material substantially elongated along the first direction 203 embedded within the cladding 230.

In some implementations, the cross-section of the centre waveguide 210, the left waveguide 211, the right waveguide 212 and the first waveguide 220 may have a predetermined shape which is substantially the same throughout the length of the centre waveguide 210, the left waveguide 211, the right waveguide 212 and the first waveguide 220. For example, the cross-section may be a square.

In some implementations, the area of the cross-section of the centre waveguide 210, the left waveguide 211, the right waveguide 212 and the first waveguide 220 may not be the same throughout the length. For example, the area may gradually increase or decrease in the first direction 203, or increase up to a point in the propagation direction, the z-direction, then decrease in the first direction 203. For example, the shape of the cross-section in this case may be maintained as a square but the aspect ratio of the square cross-section may change in the propagation direction.

The centre waveguide 210, the left waveguide 211 and the right waveguide 212 are disposed on the same plane or on the same layer, the xz-plane. In some implementations, the centre waveguide 210, the left waveguide 211 and the right waveguide 212 comprise the same material, for example, silicon nitride.

The first waveguide 220 is disposed on a different plane or on a different layer from the centre waveguide 210, the left waveguide 211 and the right waveguide 212. The layers define a plane parallel to the xz-plane. There is a finite distance in the y-direction between the layer containing the first waveguide 220 and the layer containing the centre waveguide 210, the left waveguide 211 and the right waveguide 212.

A cladding material 230, for example, silicon dioxide, is disposed between the layer containing the first waveguide 220 and the layer centre waveguide 210, the left waveguide 211 and the right waveguide 212.

In the cross section defined to be perpendicular to the first direction 203, the first waveguide 220 and a surrounding material or a cladding material 230 may form a core-cladding structure arranged to support the propagation of the second optical mode 223. The examples of the surrounding material or the cladding material 230 may include silicon dioxide.

In some implementations, the first waveguide 220 and the centre waveguide 210, the left waveguide 211 and the right waveguide 212 comprise the same material, for example, silicon nitride.

The left waveguide 211 and the right waveguide 212 extend from the first plane 201 in the propagation direction, the z-direction. From the first plane 201, the first optical mode 213 interacts with at least the left waveguide 211 and the right waveguide 212.

In some implementations, although not depicted in FIG. 2a, the centre waveguide 210 may be arranged such that when the first optical mode 213 is incident on the first plane 201, the first optical mode 213 interacts with the centre waveguide 210, the left waveguide 211 and the right waveguide 212. In this case, the centre waveguide extends to the first plane 201.

In some implementations, the centre waveguide 210 is positioned within the transverse plane, the xy-plane, at the centre of the first optical mode 213. In other words, the centre waveguide 210 is aligned with the centre of the first optical mode 213.

In some implementations, the left waveguide 211 and the right waveguide 212 have the identical dimensions.

When the second optical mode 223 exits from the second plane 202, the second optical mode 223 is supported by the first waveguide 220. The first waveguide 220 may extend further from the second plane 202. The first waveguide 220 may be connected to a photonic circuit supported by the photonic chip including the mode-size converter 200.

In a first evanescent coupling region 214, the centre waveguide 210 is evanescently coupled to the left waveguide 211 and the right waveguide 212. The first evanescent coupling region 214 is defined by the region where the centre waveguide 210 overlaps with the left waveguide 211 and the right waveguide 212, viewed in the direction normal to the propagation direction and parallel to the substrate plane, or in the yz-plane. The substrate plane is the plane of the FIG. 2a.

Since the centre waveguide 210, the left waveguide 211, and the right waveguide 212 are in the same layer in the xz-plane, the evanescent coupling is facilitated by the lateral distance, in the x-direction, between the centre waveguide 210 and the left waveguide 211 or between the centre waveguide 210 and the right waveguide 212.

Within the first evanescent coupling region 214, the left waveguide 211 or the right waveguide 212 may be positioned close enough to the centre waveguide 210 such that an evanescent coupling or nearfield interaction is possible. For example, when the operating wavelength is 1550 nm, the distance may range from 100 nm to 1.8 micron. Typically, the distance may be smaller than 400 nm. In some implementations, the distance between the left waveguide 211 and the centre waveguide 210 or between the right waveguide 212 and the centre waveguide 210 within the first evanescent coupling region 214 may change within the first evanescent coupling region 214.

The left waveguide 211 and the right waveguide 212 extend up to the end of the first evanescent coupling region 214, in the propagation direction, in the positive z-direction.

In some implementations, in case the centre waveguide starts at the first plane 201, the first evanescent coupling region 214 starts from the first plane 201.

The length of the left waveguide 211 and the right waveguide 212 in the propagation direction, the z-direction, may range from a few operating wavelengths to tens of operating wavelengths. For example, when the operating wavelength is 1550 nm, the length of the left waveguide 211 and the right waveguide 212 in the first direction 203 may range from 10 microns to 1 millimeter.

The length of the centre waveguide 210 in the propagation direction, the z-direction, may range from a few operating wavelengths to tens of operating wavelengths. For example, when the operating wavelength is 1550 nm, the length of the centre waveguide 210 in the first direction 203 may range from 10 microns to 1 milimeter.

FIGS. 2a and 2b illustrate an example where three dielectric strips, the centre waveguide 210, the left waveguide 211, and the right waveguide 212. The left waveguide 211, and the right waveguide 212 gradually transforms the mode profile of the first optical mode 213 to be narrowed and centred around the centre waveguide 210. Therefore, it is understood that a larger number of dielectric strips may be used when the size mismatch between the first optical mode 213 and the second optical mode 223. For example, 3 strips of high index dielectric strips may be arranged between the first plane 201 and the left waveguide 211, and 3 strips of high index dielectric strips may be arranged between the first plane 201 and the right waveguide 212, to reduce losses in transformation of the mode-size.

In a second evanescent coupling region 215, the centre waveguide 210 is evanescently coupled to the first waveguide 220. The second evanescent coupling region 215 is defined by the region where the centre waveguide 210 overlaps with the first waveguide 220 in plan view or viewed in a direction normal to the substrate plane or the xz-plane. In the example of FIG. 2a, part of the centre waveguide 210 is disposed under the first waveguide 220 and therefore not visible.

Since the centre waveguide 210 and the first waveguide 220 are in different layers, the evanescent coupling is facilitated by the distance between the centre waveguide 210 and the first waveguide 220 in a direction normal to the substrate plane, in the y-direction.

Within the second evanescent coupling region 215, the first waveguide 220 may be positioned close enough to the centre waveguide 210 such that an evanescent coupling or nearfield interaction is possible. For example, typical distance between the centre waveguide 210 and the first waveguide 220, provided by a cladding layer, may range from 0 nm to 1.5 micron. When the cross section of the centre waveguide 210 and the first waveguide 220 are larger than 200 nm by 200 nm, at 1.5 micron distance, the coupling is negligible. In some implementations, the ends of the left waveguide 211 and the right waveguide 212 do not reach the second evanescent coupling region 215.

In some implementations, the second evanescent coupling region 215 start immediately after the first evanescent coupling region 214. In other words, a distance 217 between the first evanescent coupling region 214 and the second evanescent coupling region 215 is zero.

In some implementations, the second evanescent coupling region 215 overlaps with the first evanescent coupling region 214. The first waveguide 220 starts within the first evanescent coupling region 214.

In some implementations, the left waveguide 211 and the right waveguide 212 are positioned at symmetric positions with respect to the centre of the first optical mode 213.

In some implementations, the refractive index of the first waveguide 220 and the cross-section of the first waveguide 220 are determined such that a waveguide formed by the first waveguide 220 as a core and the cladding 230 is above a cut-off condition for the operating wavelength and supports at least one transverse mode.

In some implementations, the refractive index of the centre waveguide 210 and the cross-section of the centre waveguide 210 may each be arranged such that a waveguide formed by the centre waveguide 210 as a core and the cladding 230 is below a cut-off condition for the operating wavelength.

In some implementations, the refractive index of the left waveguide 211 and the right waveguide 212 and the cross-section of the left waveguide 211 and the right waveguide 212 are each determined such that a waveguide formed by each of the left waveguide 211 and the right waveguide 212 as a core and the cladding 230 is below a cut-off condition for the operating wavelength.

In some implementations, the refractive index of the centre waveguide 210, the left waveguide 211 and the right waveguide 212 and the cross-section of the centre waveguide 210, the left waveguide 211 and the right waveguide 212 are each determined such that a waveguide formed by each of the centre waveguide 210, the left waveguide 211 and the right waveguide 212 as a core and the cladding 230 is below a cut-off condition for the operating wavelength.

In the first evanescent region 214, the centre waveguide 210, the left waveguide 211 and the right waveguide 212 form a “super mode” or an expanded mode in that the optical mode is not supported by each of the centre waveguide 210, the left waveguide 211 and the right waveguide 212 but supported by the combination or the “trident configuration” of the centre waveguide 210, the left waveguide 211 and the right waveguide 212.

The left waveguide 211 and the right waveguide 212 at the first plane 201 receive the first optical mode 213 and transfer the coupled optical mode to the centre waveguide 210 in the first evanescent region 214.

Due to the presence of the left waveguide 211 and the right waveguide 212, the mode area of the guided mode may gradually decrease as the guided mode propagates in the first direction 203 towards the first evanescent coupling region 214. Due to the presence of the centre waveguide 210, the guided mode becomes more concentrated near the centre waveguide 210, further decreasing the mode size.

As depicted in FIG. 2b, over the distance of the second evanescent coupling region 215, due to evanescent coupling, the guided mode may gradually transform such that the mode becomes centred around the first waveguide 220, as shown in the circle with the dotted lines 223. This will be discussed in more detail below.

As the guided mode exits the second evanescent coupling region 215, the guided mode may have a mode area substantially similar to the mode area of the second guided mode 223, such that the guided mode couples efficiently to waveguide supporting the second guided mode 223 in the waveguide chip.

The positions, widths and lengths of the centre waveguide 210, the left waveguide 211 and the right waveguide 212, can be optimised such that the first guided mode 213 couples efficiently into the second evanescent coupling region 215.

For example, a width of the centre waveguide 210, the left waveguide 211 and the right waveguide 212 may vary from 10 nm to 2 μm when the thickness of the centre waveguide 210 is 200 nm.

The conversion efficiency of the mode-size converter 200 may be defined in this specification to be the ratio of the powers of the second guided mode 223 to the first guided mode 213 in case the mode propagates in the first direction 203. The conversion efficiency of the mode-size converter 200 may be defined to be the ratio of the powers of the first guided mode 213 incident on the first plane 201 to the second guided mode 223 exiting through the second plane 202 in case the mode propagates in the opposite direction to the first direction 203. Considering that the mode-size converter 200 is a reciprocal device, the conversion efficiency may be substantially the same regardless of the propagation direction of the mode.

The length of the first evanescent coupling region 214 may be adjusted to optimise the conversion efficiency from the first optical mode 213 into the second optical mode 223.

The length of the first evanescent coupling region 214 in the first direction 203 may range from several operation wavelengths to several hundreds of operation wavelengths. For example, the length of the first evanescent coupling region 214 may range from 10 μm to 1 mm in case the operation wavelength is 1550 nm.

The length of the second evanescent coupling region 215 may be adjusted to optimise the conversion efficiency from the first optical mode 213 into the second optical mode 223.

The length of the second evanescent coupling region 215 in the first direction 203 may range from 10 microns to 5 millimeters when the operation wavelengths is within the C-band. For example, the length of the second evanescent coupling region 215 may range from 10 μm to 1 mm in case the operation wavelength is 1550 nm.

A lateral distance 216, in the x-axis, between the left waveguide 211 and the right waveguide 212 is determined such that the expanded mode matches the mode field diameter of the first optical mode 213. For example, when the mode field diameter of the first optical mode 213 is around 16.5 microns, the distance 216 between the left waveguide 211 and the right waveguide 212 is 1.675 microns.

For example, the cross-section area and the refractive index distribution in the cross-section at the first plane 201 may be arranged such that it supports the propagation of a HE11 mode of the operation wavelength. In this case, the first guided mode 213 incident from a single mode fiber may be supported by the left waveguide 211 and the right waveguide 212.

The left panel 201 of FIG. 2b shows that the first waveguide 220 is disposed in a layer above the layer containing the centre waveguide 210, the left waveguide 211 and the right waveguide 212.

The right panel 202 of FIG. 2b shows that the first waveguide 220 is disposed in a layer above the layer containing the centre waveguide 210, the left waveguide 211 and the right waveguide 212.

In both the left panel 201 and the right panel 202, circles in the dotted line represents the extent of the first optical mode 213 and the second optical mode 223 in the transverse plane, the xy-plane. The transverse optical modes have well-defined intensity distribution in the the transverse plane and it is noted that the dotted lines are rough representation of the mode filed diameter and for the guidance only.

The dotted lines for the first optical mode 213 in FIG. 2b represent the size of the optical mode at the first plane 201 and the dotted lines for the second optical mode 223 in FIG. 2b represent the size of the optical mode at the second plane 202.

The layer containing the first waveguide 220 will be referred to as a functional layer in that the first waveguide 220 may be connected to the waveguides for long distance transmission of the guided modes within the photonic circuit contained within a waveguide chip. In case the material for this layer is silicon nitride (Si3N4), the typical thickness of the functional layer, the extent in the y-direction, may range from 300 nm to 1 micron.

The layer containing the centre waveguide 210, the left waveguide 211, and the right waveguide 212 will be referred to as a coupling layer in that the structures within this layer will be mainly responsible for coupling and transforming external optical mode into a guided mode for the waveguides in the functional layer. In case the material for this layer is silicon nitride (Si3N4), the typical thickness of the coupling layer, the extent in the y-direction, may range from 50 nm to 250 nm.

The thickness, the extent in the y-direction, of the coupling layer is smaller than the thickness of the functional layer. Also, as will be discussed below, the structures in the coupling layer may act as a coupler between two separate functional layers.

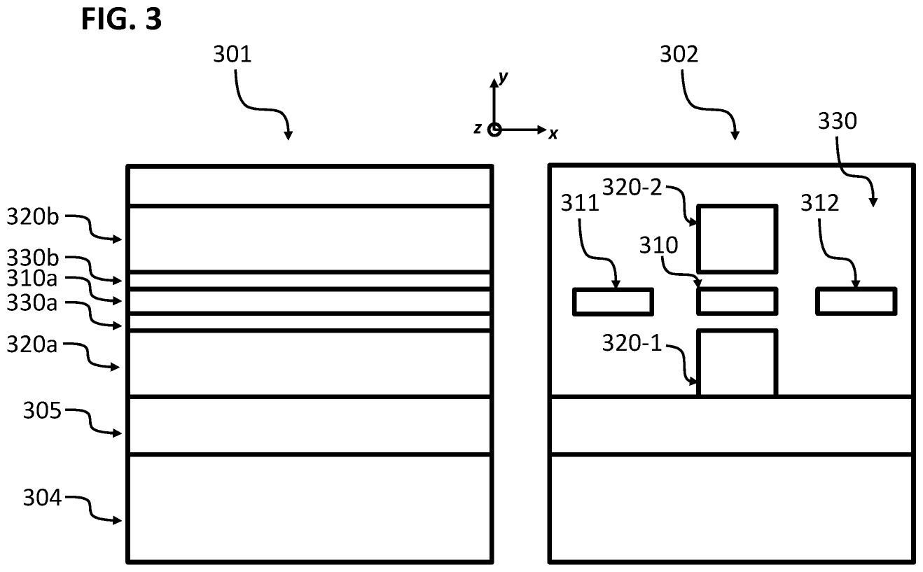

FIG. 3 is a schematic that illustrates an exemplary embodiment of a layer stack for photonic integrated circuit with references to FIG. 2.

A left panel of FIG. 3 illustrates a cross-section of an unpatterned layer stack 301 for photonic integrated circuit (PIC). The unpatterned layer stack 301 includes a substrate 304, for example, a silicon substrate and a buried oxide layer (BOX) 305 on the substrate 304.

The unpatterned layer stack 301 in the example of FIG. 3 includes a first functional layer 320a disposed on the buried oxide layer 305, a first cladding layer 330a disposed on the first functional layer 320a, a coupling layer 310a disposed on the first cladding layer 330a, a second cladding layer 330b disposed on the coupling layer 310a and a second functional layer 320b disposed on the second cladding layer 330b.

Although not shown in FIG. 3, another cladding layer may be disposed on the second functional layer 320b and another coupling layer may be disposed on that another cladding layer. In other words, the stack of functional layer/cladding layer/coupling layer, or a “thin-thick combination” may be repeated in a periodic fashion.

The unpatterned layer stack 301 further includes a compound layer stack disposed on the buried oxide layer 305. The compound layer stack corresponds to a periodic repetition of a functional layer 320a, 320b and a coupling layer 310a. A cladding layer 330a, 330b is disposed between the functional layer 320a, 320b and the coupling layer 310a to maintain distance. The arrangement of ((functional layer)-(coupling layer)-(functional layer)-(coupling layer)- . . . ) may be repeated as many times as desired in the layer stack.

In some implementations, the material for the functional layers 320a, 320b and the coupling layer 310a are silicon nitride and the material for the cladding layer 310a is silicon dioxide.

Atypical thickness of the functional layer 320a, 320b may range from 300 nm to 1 micron, typically 800 nm. A typical thickness of the coupling layer 310a may range from 50 nm to 250 nm, typically 200 nm. A typical thickness of the cladding layer 330a, 330b may range from 0 nm, where the cladding layer is non-existent, to 1 micron, typically 100 nm.

A right panel of FIG. 3 illustrates a cross-section of an example of a patterned layer stack 302 for photonic integrated circuit (PIC). Each of the layers of the patterned layer stack 302 corresponds to the layers of the unpatterned stack 301 shown in the left panel of FIG. 3.

The structures of the patterned layer stack are obtained by patterning the layers of the unpatterned stack 301. A lower first waveguide 320-1 disposed on the buried oxide layer 305 is patterned within the first functional layer 320a. The centre waveguide 310, the left waveguide 311, and the right waveguide 312 are patterned within the coupling layer 310a. A upper first waveguide 320-2 is patterned within the second functional layer 320b. The rest of the space after patterning each layer is filled with a cladding material 330 by depositing the cladding material 330 after patterning each layer.

The left panel 301 and the right panel 302 of FIG. 3 also illustrate that the photonic circuits formed in multiple layers with the waveguides patterned on the functional layers 320a, 320b and that the photonic circuits on each functional layer 320a, 320b can be coupled via the coupling layers 310a disposed between them.

The left panel 301 and the right panel 302 of FIG. 3 illustrate that the mode-size converter 200 described in FIG. 2 can be patterned based on the same layer structure as the unpatterned stack 301. Therefore, the deposition condition of each layers known from the unpatterned stack 301 can be reproduced for disposing a layer to be patterned in the patterned stack 302.

The left panel 201 of FIG. 2 corresponds to the arrangement where the upper first waveguide 320-2 is present and the lower first waveguide 320-1 is replaced with the cladding material 330. The right panel 202 of FIG. 2 corresponds to the arrangement where the lower first waveguide 320-1 is present and the upper first waveguide 320-2 is replaced with the cladding material 330. As discussed above, these two configurations function in an identical fashion and the choice depends on the larger photonic circuits which can be multi-layered. The patterned stack 320 described in FIG. 3 is to demonstrate that any of these configurations can be fabricated within the multi-layer configuration of the unpatterned stack 301.

With the mode-size converter illustrated in FIG. 2, the coupling layers 310a may function as an optical interface (I/O) element for the waveguide circuits, such as the mode-size converters 100, 200, formed on functional layers 320a, 320b immediately above and below the coupling layer 310a.

Therefore, the coupling layer 310a serves either for optical interface or for transferring light between any of adjacent functional layers 320a, 320b.

Since the optical interface is fabricated on a separate layer from the waveguide circuits, the fabrication processes can be simplified compared to the case where the components for optical interfacing is fabricated on the same layer as the waveguide circuits.

Since the layer dedicated for the optical interfacing can also be used for coupling between two adjacent layers of waveguide circuits, the fabrication can further be simplified and errors from fabrication tolerances can be minimised.

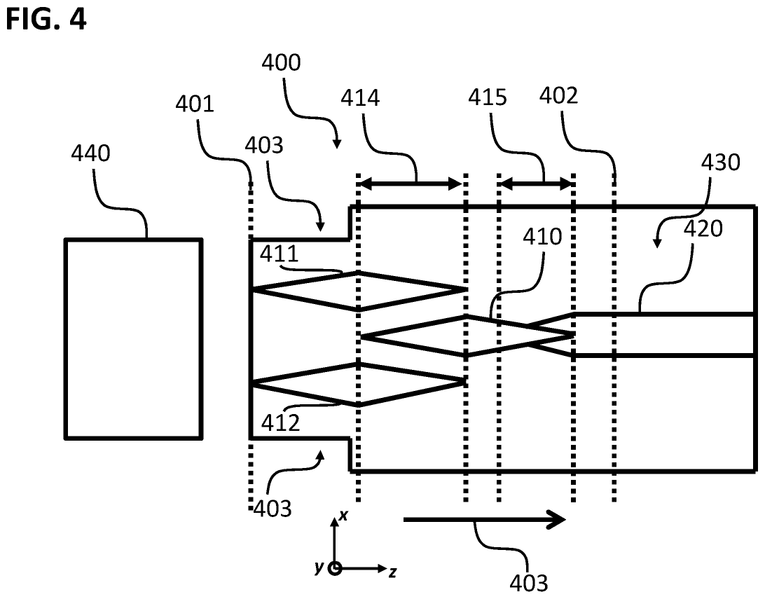

FIG. 4 is a schematic that illustrates an exemplary embodiment of the mode-size converter with references to FIGS. 1 and 2.

The mode-size converter 400 operates as explained for the mode-size converters 100, 200 in FIGS. 1 and 2. For example, the first plane 401 may be a facet of a waveguide chip. For example, a cleaved single-mode optical fiber 440 can be approached to the facet of the waveguide chip to couple mode in.

The optical mode input at the first plane 401 is coupled to the left waveguide 411 and the right waveguide 412 and subsequently the centre waveguide 410. These are embedded in the cladding material 430. The mode-size converter 400 converts the mode-size input into the first plane 401 into a mode supported by the first waveguide 420.

The exemplary embodiment of the mode-size converter 400 includes following further features.

In some implementations, the mode-size converter 400 includes a trench 403 near the first plane 401. To improve the guiding and confinement of the optical mode input at the first plane 401, part of the cladding material 430 can be removed. For example, when the mode field diameter is 7 microns, the cladding material 430 can be removed from 4 microns from the central axis of the optical mode and outside the positions of the left waveguide 411 and the right waveguide 412 such that the cladding material 430 with 8 microns width supports the optical mode incident on the first plane 401.

In the first and second evanescent coupling region 414, 415, when the width of one waveguide increases, the width of the waveguide evanescently coupled to that waveguide can decrease such that the expansion of the mode area is continuous and the scattering is minimised, which maximises the coupling efficiency. The thickness of the left waveguide 411, the right waveguide 412 and the centre waveguide 410 and the thickness of the first waveguide 420 remain constant throughout the coupler 400.

In some implementations, the left waveguide 411 and the right waveguide 412 are tapered towards the first evanescent coupling region 414 such that the coupling of the incoming optical mode is achieved with minimum possible scattering. From the first plane 401, the width, the extent in the x-direction, of the left waveguide 411 and the width of the right waveguide 412 gradually increase in the propagation direction, the z-direction. In some implementations, the width of the left waveguide 411 and the right waveguide 412 at the first plane 401 is zero or minimised.

In this specification, the term “tapered” will be understood to mean that the cross-section area of a waveguide gradually changes along the propagation direction. The term “gradually” also encompasses step-wise changes of one or more of the transverse dimension of the cross-section of the waveguide, in so far as the step-wise change does not lead to excessive scattering of light which will lead to severe loss.

In some implementations, within the first evanescent coupling region 414, the left waveguide 411 and the right waveguide 412 are tapered down towards end of the first evanescent coupling region 414. Within a first evanescent coupling region 414, the width, the extent in the x-direction, of the left waveguide 411 and the width of the right waveguide 412 gradually decrease in the propagation direction 403, the z-direction.

In some implementations, within the first evanescent coupling region 414, the centre waveguide is tapered. From the beginning of the first evanescent coupling region 414, the width, the extent in the x-direction, of the centre waveguide 410 gradually increases in the propagation direction, the z-direction. In some implementations, the width of the centre waveguide 410 at the beginning of the first evanescent coupling region 414 is zero or minimised.

In some implementations, within the first evanescent coupling region 414, the distance between the side surfaces, normal to the plane of the substrate or the xz-plane, of the centre waveguide 410 and the left waveguide 411 and the distance between the side surfaces of the centre waveguide 410 and the right waveguide 412 are kept constant throughout the first evanescent coupling region 414. In other words, the opposing side surfaces of the centre waveguide 410 and the left waveguide 411 are parallel to each other and the opposing side surfaces of the centre waveguide 410 and the right waveguide 412 are parallel to each other.

In some implementations, within the second evanescent coupling region 415, the first waveguide 420 is tapered up and the centre waveguide 410 is tapered down in the propagation direction. The width, the extent in the x-direction, of the centre waveguide 410 gradually decreases and the width of the first waveguide 420 gradually increases in the propagation direction, the z-direction. In this case, in some implementations, the width of the centre waveguide 410 at the end of the second evanescent coupling region 415 is zero or minimised.

In some implementations, the start of the first waveguide 420 coincides with the start of the second evanescent coupling region 415. In this case, the width of the first waveguide 410 increases until the end of the second evanescent coupling region 415. In some implementations, the start of the centre waveguide 410 coincides with the first plane 401. In this case, the width of the first waveguide 410 increases from the first plane 401 until the end of the first evanescent coupling region 414.

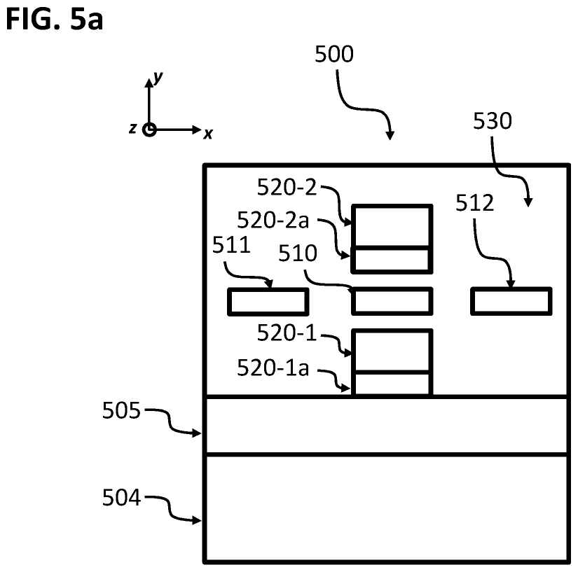

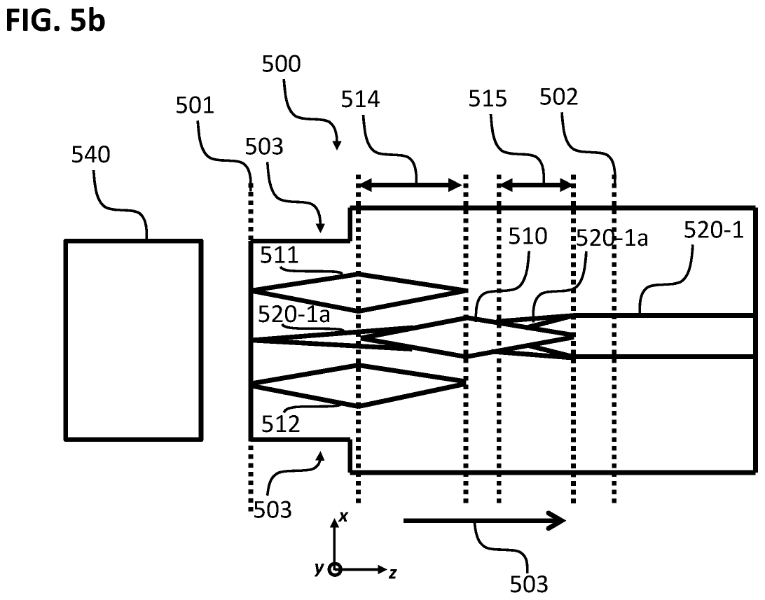

FIGS. 5a and 5b are a schematic that illustrates an exemplary embodiment of the mode-size converter 200 with references to FIGS. 2a, 2b, 3 and 4.

FIG. 5a shows a cross-section of the mode-size converter 500. The mode-size converter 500 in the example of FIGS. 5a and 5b includes all of the features described in the FIGS. 2a, 2b and 3. The mode-size converter 500 includes the lower first waveguide 520-1 disposed on the BOX layer 505 and the substrate 504, the upper first waveguide 520-2, the centre waveguide 510, the left waveguide 511, and the right waveguide 512.

In particular, as explained in FIG. 3, although the cross-section shows both the lower first waveguide 520-1 and the upper first waveguide 520-2, this is to show that the same layer including the centre waveguide 510, the left waveguide 511, and the right waveguide 512 can function as an optical interface for both the lower first waveguide 520-1 and the upper first waveguide 520-2. As shown in FIG. 2b, either of the lower first waveguide 520-1 or the upper first waveguide 520-2 is included in the mode-size converter.

The mode-size converter described in FIGS. 5a and 5b includes the following further features.

In some implementations, the lower first waveguide 520-1 or the upper first waveguide 520-2 further includes a shallow section 520-1a, 520-2a.

In this case, the lower first waveguide 520-1 or the upper first waveguide 520-2 comprise a first layer and a second layer. The second layer 520-1a of the lower first waveguide 520-1 extends further towards the first plane 501 than the first layer to the coupling layer or the layer containing the centre waveguide 510, the left waveguide 511, and the right waveguide 512. The second layer 520-2a of the upper first waveguide 520-2 is closer than the first layer to the coupling layer or the layer containing the centre waveguide 510, the left waveguide 511, and the right waveguide 512. The second layer 520-1a, 520-2a corresponds to the shallow section 520-1a, 520-2a.

The second layer or the shallow section 520-1a, 520-2a may be arranged to have a different extent in the propagation direction, the z-direction and in the width direction, the x-direction than the rest of the first waveguide 520-1, 520-2 or the first layer. The shallow section 520-1a, 520-2a or the second layer starts closer to the first plane 501 than the first layer of the lower first waveguide 520-1 or the upper first waveguide 520-2.

FIG. 5b shows an example where the mode-size converter 500 is formed with the lower first waveguide 520-1 and the lower first waveguide 520-1 includes a shallow section 520-1a.

Apart from the shallow of section 520-1a, all of the other features are as explained in FIG. 4. Therefore, the description on the first plane 501, the second plane 502, the trench 503, the centre waveguide 510, the left waveguide 511, the right waveguide 512, the first evanescent coupling region 514 and the second evanescent coupling region 515 will not be repeated here.

As shown in FIG. 5b, the shallow section 520-1a extends to the first plane 501 and is tapered towards the end of the second evanescent coupling region 515. The width of the shallow section 520-1a gradually increases in the propagation direction, the z-direction, until the end of the second evanescent coupling region 515.

The part of the lower first waveguide 520-1 above the shallow section 520-1a is arranged in the xz-plane as described in FIG. 4: starts from the beginning of the second evanescent coupling region 515 and is tapered up towards the end of the second evanescent coupling region 515. The shallow section 520-1a and the part of the lower first waveguide 520-1 above the shallow section 520-1a merge to provide a square cross section as shown in FIG. 5a at the end of the second evanescent coupling region 515.

The arrangement of the first waveguide 520-1, 520-2 to include the shallow section 520-1a, 520-2a further reduce coupling losses because it provides a more gradual transition of the cross-section in the thickness direction, the y-direction.

When the thickness, the extent in the y-direction, of the first waveguide 520-1, 520-2 is 800 nm, the thickness of the shallow section 520-1a is set to be less than 500 nm considering fabrication tolerances.

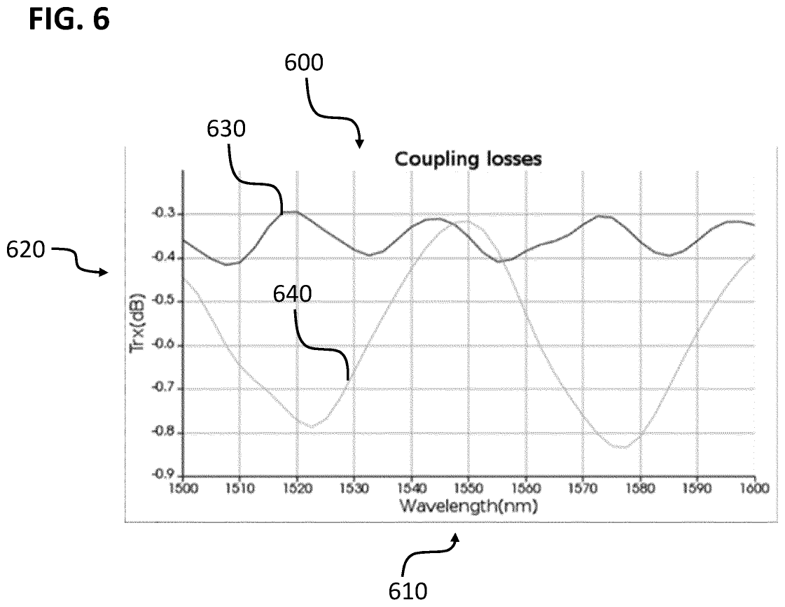

FIG. 6 is a simulation result of the coupling loss of the mode-size converter.

A graph 600 shows the results of optical simulations of coupling losses, shown in a vertical axis 620 as a function of the wavelength, shown in a horizontal axis 610. The coupling loss is obtained by taking a power ratio of the input power at the first plane 101, 201, 401, 501 to the power coupled into the first waveguide 220, 420, 320-1, 320-2, 520 at a fixed distance away from the second plane 102, 202, 402, 502.

Simulations were performed based on the embodiment of FIG. 4, assuming that the dimension of the centre waveguide 410, the left waveguide 411, and the right waveguide 412 are identical. The length in the z-direction of the centre waveguide 410, the left waveguide 411, and the right waveguide 412 was set to be 500 microns. The largest width in the x-direction of the centre waveguide 410, the left waveguide 411, and the right waveguide 412 was set to be 1 micron. This width tapered down to 200 nm tip width in both positive and negative z-direction over 250 microns taper length. The width of waveguide 420 is tapered from 800 nm down to 200 nm in taper region 415, which is also 250 um long. In particular, although FIG. 4 depicts the ends or tips of the centre waveguide 410, the left waveguide 411, and the right waveguide 412 as a dimensionless point, the tip width of 200 nm was set in the simulation considering the fabrication tolerance. 800 nm thickness and 800 nm width were assumed for the first waveguide 420. The material for the first waveguide 420 was silicon nitride and the cladding material 430 was silicon dioxide. The material for the centre waveguide 410 the left waveguide 411 and the right waveguide 412 was also silicon nitride. The thicknesses of the centre waveguide 410 the left waveguide 411 and the right waveguide 412 was 200 nm.

The first waveguide supports both TE mode and TM mode. The coupling loss for the TM mode is shown in a first curve 630 and the coupling loss for the TE mode is shown in a second curve 640. In both cases, the coupling loss is less than 1 dB.

The embodiments of the invention shown in the drawings and described above are exemplary embodiments only and are not intended to limit the scope of the invention, which is defined by the claims hereafter. It is intended that any combination of non-mutually exclusive features described herein are within the scope of the present invention.

### Statement of Financial Support

The project leading to this application has received funding from the European Union's Horizon 2020 research and innovation programme under grant agreement No. 954530.

1. An optical mode-size converter, extending between a first plane to a second plane along a first path, the optical mode-size converter comprising:
a plurality of dielectric strips within a coupling layer arranged to receive a beam with a first optical mode incident on the first plane, wherein the plurality of dielectric strips are coupled to each other in a first evanescent coupling region; and
a first waveguide within a functional layer disposed above or below the coupling layer, the waveguide supporting a second optical mode and traversing the second plane,
wherein at least one of the plurality of dielectric strips is evanescently coupled to the first waveguide in a second evanescent coupling region,
wherein the first optical mode has a larger mode size than the second optical mode,
such that the converter is responsive to the first optical mode incident on the first plane to convert the first optical mode into the second optical mode in the first waveguide, along the first path towards the second plane, and
wherein the first waveguide comprises a first layer and a second layer, and
wherein an end of the second layer is closer to the first plane than an end of the first layer.

2. The optical mode-size converter of claim 1,
wherein the plurality of dielectric strips comprises:
a centre waveguide aligned with the first waveguide in plan view;
a left waveguide; and
a right waveguide,
wherein the left waveguide and the right waveguide start at the first plane, and disposed at opposite sides from each other with respect to the centre waveguide,
wherein a first portion of the centre waveguide is evanescently coupled to the left waveguide and the right waveguide in the first evanescent coupling region, and
wherein a second portion of the centre waveguide is evanescently coupled to the first waveguide in the second evanescent coupling region.

3. The optical mode-size converter of claim 2,
wherein the left waveguide and the right waveguide have the identical dimensions.

4. The optical mode-size converter of claim 2,
wherein the left waveguide and the right waveguide are positioned at symmetric positions with respect to a centre of the first optical mode.

5. The optical mode-size converter of claim 1, wherein the plurality of dielectric strips comprises:
a centre waveguide aligned with the first waveguide in plan view;
a left waveguide; and
a right waveguide,
wherein the left waveguide and the right waveguide are disposed at opposite sides from each other with respect to the centre waveguide,
wherein a first portion of the centre waveguide is evanescently coupled to the left waveguide and the right waveguide in the first evanescent coupling region,
wherein a second portion of the centre waveguide is evanescently coupled to the first waveguide in the second evanescent coupling region, and
wherein the plurality of dielectric strips further comprises:
three high index dielectric strips arranged between the first plane and the left waveguide; and
three high index dielectric strips arranged between the first plane and the right waveguide.

6. The optical mode-size converter of claim 1,
wherein a width of the first waveguide gradually increases towards the second plane.

7. The optical mode-size converter of claim 3,
wherein in the first evanescent coupling region:
a width of the left waveguide and a width of the right waveguide gradually decrease towards the second plane, and
a width of the first portion of the centre waveguide increases gradually towards the second plane.

8. The optical mode-size converter of claim 7,
wherein a distance between side surfaces of the left waveguide and the first portion of the centre waveguide and a distance between side surfaces of the right waveguide and the first portion of the centre waveguide are constant within the first evanescent coupling region.

9. The optical mode-size converter of claim 3,
wherein in the second evanescent coupling region:
a width of the second portion of the centre waveguide decreases gradually towards the second plane, and
a width of the first waveguide increases gradually towards to second plane.

10. The optical mode-size converter of claim 1,
wherein the first waveguide starts at the first plane.

11. The optical mode-size converter of claim 1,
wherein the first waveguide starts at the second evanescent coupling region.

12. The optical mode-size converter of claim 1, wherein:
a width of the second layer increases gradually towards the second plane up to an end of the second evanescent coupling region; and
a width of the first layer increases gradually within the second evanescent coupling region towards the second plane.

13. The optical mode-size converter of claim 1,
wherein the converter is embedded in a waveguide chip, and
wherein the first plane comprises a facet of the waveguide chip.

14. The optical mode-size converter of claim 1, further comprising:
a trench wherein a material is removed near the first plane at a first distance from the centre of the first optical mode, configured to guide the first optical mode incident on the first plane.

15. The optical mode-size converter of claim 1, wherein the first waveguide has a thickness in a range of 300 nm to 1 micron and each of the dielectric strips has a thickness in a range of 50 nm to 250 nm.

16. The optical mode-size converter of claim 15, wherein the first waveguide has a thickness of 800 nm and each of the dielectric strips has a thickness of 200 nm.

17. The optical mode-size converter of claim 1, wherein the first waveguide comprises silicon nitride and each of the dielectric strips comprises silicon nitride.
